(19) United States
(12) Patent Application Publication
(10) Pub. No.: US 2013/0194403 A1
(43) Pub. Date: Aug. 1, 2013

(54) ENDOSCOPE APPARATUS, IMAGE PROCESSING METHOD, AND INFORMATION STORAGE DEVICE

(71) Applicant: Olympus Corporation, Tokyo (JP)

(72) Inventor: Keiji HIGUCHI, Tokyo (JP)

(73) Assignee: Olympus Corporation, Tokyo (JP)

(21) Appl. No.: 13/738,266

(22) Filed: Jan. 10, 2013

(30) Foreign Application Priority Data
Jan. 27, 2012 (JP) 2012-014893

(51) Int. Cl. H04N 5/232

(52) U.S. Cl. CPC H04N 5/23251
USPC 348/65

(57) ABSTRACT

An endoscope apparatus includes an imaging section that captures a plurality of images in time series using an objective optical system, a range setting section that sets at least one of a search range and a non-search range to a reference image among the plurality of images, the search range including a center area, and the non-search range including a peripheral area, a motion detection section that performs a motion detection process that detects a motion between a processing target image and the reference image, and an image blending section that blends the processing target image and the reference image based on the motion detection process, the motion detection section setting a processing target area to the processing target image, and performing the motion detection process by searching an area that corresponds to the processing target area within a range based on the search range and/or the non-search range.

Japanese Patent Application No. 2012-014893 filed on Jan. 27, 2012, is hereby incorporated by reference in its entirety.

### BACKGROUND

The present invention relates to an endoscope apparatus, an image processing method, an information storage device, and the like.

An endoscope apparatus has been widely used that applies illumination light to tissue in a body cavity, and allows the user to perform diagnosis or procedure using an image obtained by capturing the light reflected by the tissue. An image sensor (e.g., CCD sensor or CMOS sensor), and an objective lens that optically forms an image of the object are provided on the end of the insertion section. A wide-angle objective lens is normally used as the objective lens of an endoscope in order to prevent a situation in which a lesion area is missed. For example, JP-A-2011-53352 discloses an endoscope apparatus that provides a wide angle of view using a wide-angle lens (e.g., fish-eye lens).

Since the back side of folds and the like in a body cavity can be observed by utilizing a wide-angle objective lens, it is possible to prevent a situation in which a lesion area that is difficult to observe using a normal optical system is missed.

A noise reduction process may be performed when the captured image contains a large amount of noise. The noise reduction process may be implemented in various ways. A spatial-direction noise reduction process that utilizes an attention pixel and its peripheral pixels has been widely employed. A time-direction noise reduction process that performs an average calculation process based on information about an image that has been acquired previously may also be used.

When using the time-direction noise reduction process, the previous image and the current image differ in acquisition timing, and the object and the insertion section are not necessarily stationary. Therefore, the average calculation process is performed after performing a motion detection process that detects the position of the current image that corresponds to a given area of the previous image. The motion detection process may be implemented by a known block matching process or the like.

When blending a plurality of images captured at different timings using a known super-resolution process to generate a high-resolution image, the plurality of images are normally blended after subjecting the plurality of images to the motion detection process.

### SUMMARY

According to one aspect of the invention, there is provided an endoscope apparatus comprising:

an imaging section that captures a plurality of images in time series using an objective optical system;

a range setting section that sets at least one of a search range and a non-search range to a reference image among the plurality of images, the search range including a center area of the reference image, and the non-search range including a peripheral area of the reference image;

a motion detection section that performs a motion detection process that detects a motion between a processing target image and the reference image, the processing target image being an image among the plurality of images that differs from the reference image; and

an image blending section that blends the processing target image and the reference image based on results of the motion detection process,

the motion detection section setting a processing target area to the processing target image, performing the motion detection process by searching an area that corresponds to the processing target area at least within the search range set to the reference image when the range setting section has set the search range, and performing the motion detection process by searching an area that corresponds to the processing target area at least within a range other than the non-search range when the range setting section has set the non-search range.

According to another aspect of the invention, there is provided an image processing method comprising:

setting at least one of a search range and a non-search range to a reference image among a plurality of images captured in time series using an objective optical system, the search range including a center area of the reference image, and the non-search range including a peripheral area of the reference image;

setting a processing target area to a processing target image among the plurality of images that differs from the reference image;

performing a motion detection process by searching an area that corresponds to the processing target area at least within the search range set to the reference image when the search range has been set to the reference image;

performing the motion detection process by searching an area that corresponds to the processing target area at least within a range of the reference image other than the non-search range when the non-search range has been set to the reference image; and

blending the processing target image and the reference image based on results of the motion detection process.

According to another aspect of the invention, there is provided a computer-readable storage device with an executable program stored thereon, wherein the program instructs a computer to perform steps of:

capturing a plurality of images in time series;

setting at least one of a search range and a non-search range to a reference image among the plurality of images, the search range including a center area of the reference image, and the non-search range including a peripheral area of the reference image;

performing a motion detection process that detects a motion between a processing target image and the reference image, the processing target image being an image among the plurality of images that differs from the reference image; and

blending the processing target image and the reference image based on results of the motion detection process,

the motion detection process setting a processing target area to the processing target image, searching an area that corresponds to the processing target area at least within the search range set to the reference image when the search range has been set to the reference image, and searching an area that corresponds to the processing target area at least within a range other than the non-search range when the non-search range has been set to the reference image.

### BRIEF DESCRIPTION OF THE DRAWINGS

FIG. 1 illustrates a system configuration example according to an embodiment of the invention.

FIG. 2 illustrates an example of a search range and a non-search range set to a reference image.

FIG. 3 illustrates a configuration example of an omnidirectional optical system that captures a front field of view and a side field of view.

FIG. 4A is a front cross-sectional view illustrating an omnidirectional optical system, and FIG. 4B is a side cross-sectional view illustrating an omnidirectional optical system.

FIG. 5A illustrates an example of an image acquired using an omnidirectional optical system, and FIG. 5B illustrates an example of a non-search range set to a reference image acquired using an omnidirectional optical system.

FIG. 6 illustrates a method that deforms a non-search range corresponding to a change in zoom magnification of an objective optical system.

FIG. 7 illustrates an example in which a processing target image and a reference image are selected from a plurality of images captured in time series.

### DESCRIPTION OF EXEMPLARY EMBODIMENTS

According to one embodiment of the invention, there is provided an endoscope apparatus comprising:

an imaging section that captures a plurality of images in time series using an objective optical system;

a range setting section that sets at least one of a search range and a non-search range to a reference image among the plurality of images, the search range including a center area of the reference image, and the non-search range including a peripheral area of the reference image;

a motion detection section that performs a motion detection process that detects a motion between a processing target image and the reference image, the processing target image being an image among the plurality of images that differs from the reference image; and

an image blending section that blends the processing target image and the reference image based on results of the motion detection process,

the motion detection section setting a processing target area to the processing target image, performing the motion detection process by searching an area that corresponds to the processing target area at least within the search range set to the reference image when the range setting section has set the search range, and performing the motion detection process by searching an area that corresponds to the processing target area at least within a range other than the non-search range when the range setting section has set the non-search range.

According to another embodiment of the invention, there is provided an image processing method comprising:

setting at least one of a search range and a non-search range to a reference image among a plurality of images captured in time series using an objective optical system, the search range including a center area of the reference image, and the non-search range including a peripheral area of the reference image;

setting a processing target area to a processing target image among the plurality of images that differs from the reference image;

performing a motion detection process by searching an area that corresponds to the processing target area at least within the search range set to the reference image when the search range has been set to the reference image;

performing the motion detection process by searching an area that corresponds to the processing target area at least within a range of the reference image other than the non-search range when the non-search range has been set to the reference image; and

blending the processing target image and the reference image based on results of the motion detection process.

According to another embodiment of the invention, there is provided a computer-readable storage device with an executable program stored thereon, wherein the program instructs a computer to perform steps of:

capturing a plurality of images in time series;

setting at least one of a search range and a non-search range to a reference image among the plurality of images, the search range including a center area of the reference image, and the non-search range including a peripheral area of the reference image;

performing a motion detection process that detects a motion between a processing target image and the reference image, the processing target image being an image among the plurality of images that differs from the reference image; and

blending the processing target image and the reference image based on results of the motion detection process,

the motion detection process setting a processing target area to the processing target image, searching an area that corresponds to the processing target area at least within the search range set to the reference image when the search range has been set to the reference image, and searching an area that corresponds to the processing target area at least within a range other than the non-search range when the non-search range has been set to the reference image.

Exemplary embodiments of the invention are described below. Note that the following exemplary embodiments do not in any way limit the scope of the invention laid out in the claims. Note also that all of the elements described in connection with the following exemplary embodiments should not necessarily be taken as essential elements of the invention.

### 1. Method

A method employed in connection with several embodiments of the invention is described below. An endoscope apparatus developed in recent years may utilize a super-wide angle optical system (e.g., an optical system having an angle of view of larger than 180°). Since the back side of folds and the like in a body cavity can be observed by utilizing a wide-angle optical system, it is possible to prevent a situation in which a lesion area that is difficult to observe using a normal optical system is missed, for example. Examples of the wide-angle optical system include a fish-eye lens and the like.

However, when using an optical system having a very wide angle of view, the peripheral area of the acquired image is significantly affected by distortion or the like. This poses a problem particularly when detecting motion information (e.g., motion vector) about the motion between a plurality of images acquired in time series. Specifically, since the motion detection process is normally performed by a block matching process or the like, a feature quantity (e.g., the shape of the object) is an important index. It may be difficult to accurately detect the motion when the amount of deformation or the like of the object due to distortion is large. For example, it is difficult to detect the motion between two images due to difficulty in matching when the object is captured in the center area of one of the images in a state in which the amount of distortion is small, and captured in the peripheral area of the other image in a state in which the amount of distortion is large.

One of two images subjected to the motion detection process is referred to as “processing target image”, and the other image is referred to as “reference image”. The block matching process sets a matching unit block (hereinafter referred to as “processing target area”) to the processing target image, and searches an area of the reference image that corresponds to the processing target area (i.e., an area of the reference image that has a high correlation with the processing target area). When the object is captured in the center area of the processing target image, and captured in the peripheral area of the reference image, it may be impossible to find an area of the reference image that corresponds to the processing target area that is set to the center area of the processing target image. More specifically, since the object is captured in the processing target image in a state in which the amount of distortion is small, and captured in the reference image in a state in which the amount of distortion is large, it may be determined that the correlation between the corresponding areas of the processing target image and the reference image is low during the matching process. For example, it may be determined that the correlation with an area in which a different object is captured is high. In this case, motion information that significantly differs from the actual motion information is detected, so that the subsequent process is adversely affected.

In order to deal with the above problem, several aspects of the invention employ a method that limits the area subjected to the motion detection process. More specifically, at least one of a search range and a non-search range is set to the reference image, and an area of the reference image that corresponds to the processing target area of the processing target image is searched within the search range (or the range outside the non-search range). In other words, the range outside the search range (or the non-search range) is not subjected to the search process (e.g., block matching process).

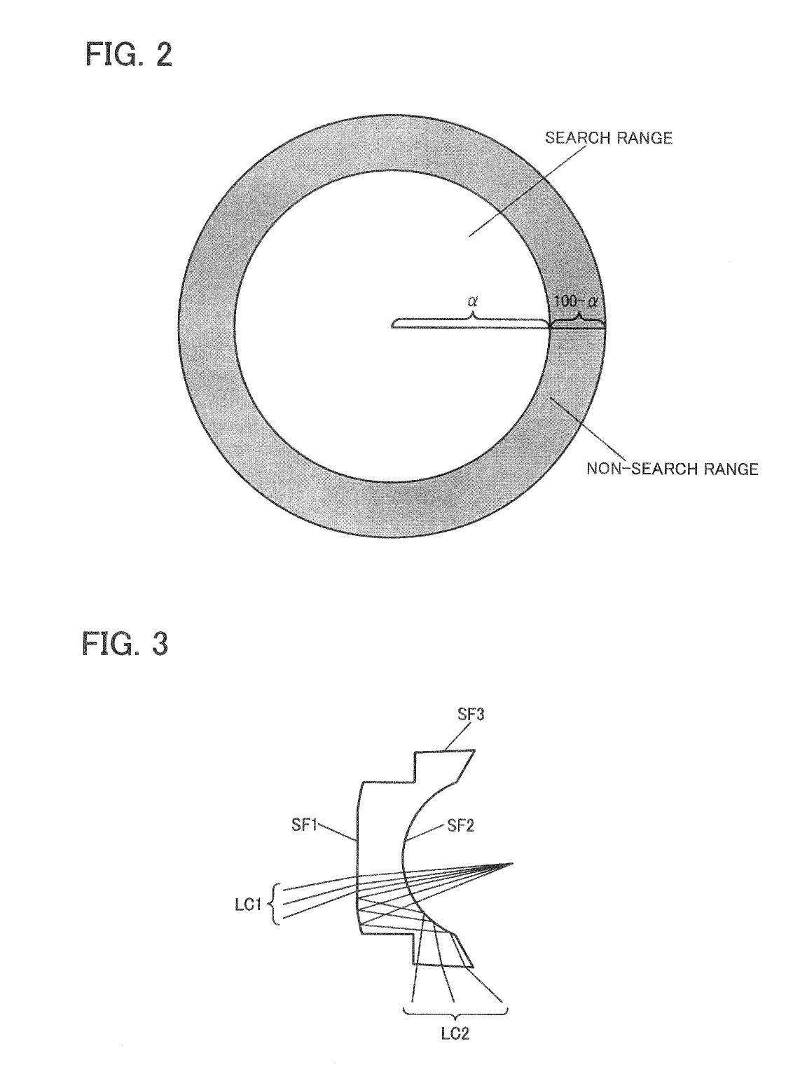

The search range or the non-search range may be set as illustrated in FIG. 2, for example. Note that the shape of the search range or the non-search range is not limited to the shape illustrated in FIG. 2. For example, the search range or the non-search range may be set to have a shape that differs from the shape illustrated in FIG. 2 on condition that a range in which distortion that adversely affects the accuracy of the motion detection process (e.g., block matching process) is set as the range outside the search range (or the non-search range).

This makes it possible to skip detection of the motion information when it is difficult to detect the motion, for example. This prevents a situation in which motion information that significantly differs from the actual motion information is detected, so that the accuracy of the subsequent process can be improved, for example.

An image blending process may be performed as the subsequent process that utilizes the motion information. For example, a pixel of the reference image that is determined to correspond to the same object as that captured at a given pixel of the processing target image is detected, and the given pixel of the processing target image and the pixel of the reference image that corresponds to the given pixel of the processing target image (a peripheral pixel of the pixel of the reference image that corresponds to the given pixel of the processing target image may also be used) are blended to achieve noise reduction in the time direction. It is also possible to acquire an image that has a number of pixels (resolution) larger than that of the processing target image and the reference image by detecting the motion information on a subpixel basis, and performing an image blending process that corresponds to a pixel-shift state.

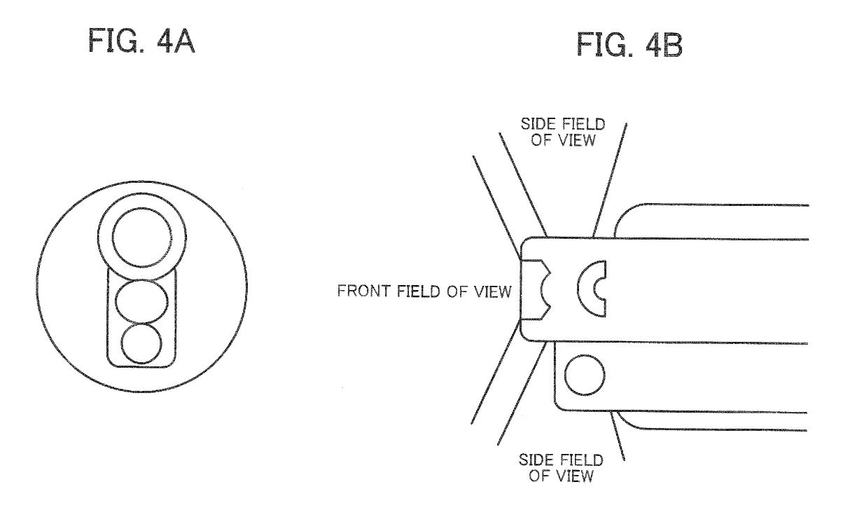

A first embodiment illustrates an example when using a fish-eye lens. A modification of the first embodiment illustrates an example in which the size of the search range (or the non-search range) is changed when the zoom magnification of the optical system or the like has changed. A second embodiment illustrates an example in which a front image that corresponds to the front field of view and a side image that corresponds to the side field of view are captured, and blended to acquire a captured image (i.e., omnidirectional optical system) (see FIGS. 3 and 4B). When using the omnidirectional optical system, the boundary area between the front image and the side image may hinder the motion detection process. Therefore, the position and the shape of the search range (or the non-search range) differ from those employed when using a fish-eye lens.

### 2. First Embodiment

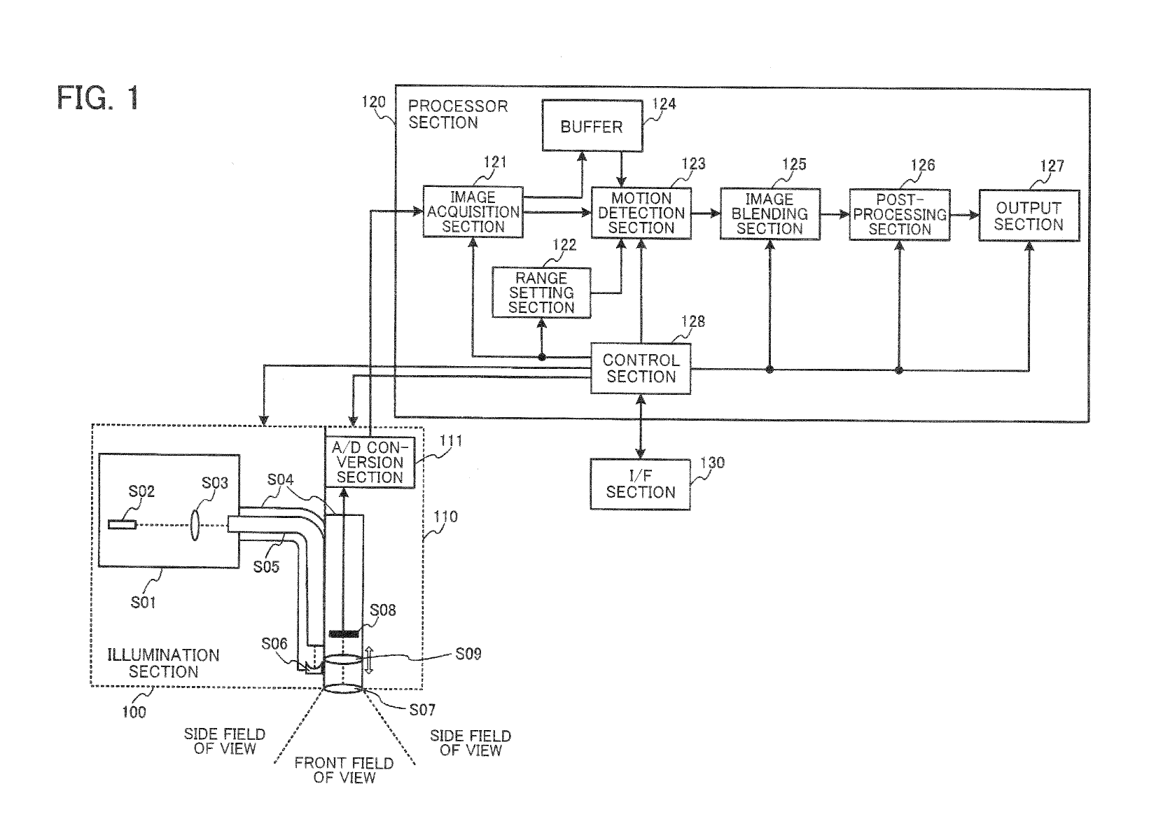

FIG. 1 illustrates a system configuration example of an endoscope apparatus according to the first embodiment. As illustrated in FIG. 1, the endoscope apparatus includes an illumination section 100 that includes a light source device S01 that includes a white light source S02 and a condenser lens S03, a light guide fiber S05, and an illumination optical system S06. The endoscope apparatus also includes an imaging section 110 that includes a condenser lens S07, an image sensor S08, a zoom lens S09, and an A/D conversion section 111. The condenser lens S07 has a distorted lens surface. An image can be captured at a wide angle of view when using a wide-angle lens.

The endoscope apparatus also includes a processor section 120 that includes an image acquisition section 121, a range setting section 122, a motion detection section 123, a buffer 124, an image blending section 125, a post-processing section 126, an output section 127, and a control section 128. The control section 128 includes a microcomputer, a CPU, and the like.

The endoscope apparatus further includes an I/F section 130. The I/F section 130 includes a power switch, a variable setting interface, and the like.

The connection relationship between the above sections is described below. The white light source S02 included in the light source device S01 emits white light. The white light reaches the condenser lens S03, and is condensed by the condenser lens S03. The condensed white light passes through the light guide fiber S05, and is applied to the object from the illumination optical system S06.

The white light reflected by the object is condensed by the condenser lens S07, and reaches the image sensor S08. The image sensor S08 photoelectrically converts the reflected light to generate an analog signal, and outputs the analog signal to the A/D conversion section 111. The A/D conversion section 111 converts the analog signal into a digital signal, and outputs the digital signal to the image acquisition section 121.

The image acquisition section 121 performs image processing (e.g., optical black process and white balance process) on the digital signal output from the A/D conversion section 111 to acquire an image. The image acquisition section 121 outputs the acquired image to the motion detection section 123, and stores the acquired image in the buffer 124.

The range setting section 122 sets a non-search range to a reference image under control of the control section 128, the non-search range being a range in which an area (reference area) having a high correlation with a processing target area of a processing target image is not searched by a known block matching process or the like. As illustrated in FIG. 2, a range that includes the peripheral area of the image and is positioned on the outer side of a boundary may be set as the non-search range, the boundary being positioned away from the center of the image by α% of the distance from the center of the image to the outer edge of the image. The value α may be set in advance before shipment of the endoscope product, or may be set by the user via the I/F section 130. Note that the range setting section 122 may also set a search range which includes the center area of the image and in which an area (reference area) having a high correlation with the processing target area is searched (i.e., the range setting section 122 may set both the search range and the non-search range).

The motion detection section 123 divides the entire processing target image (i.e., current image) into a plurality of processing target areas, and searches an area of the reference image (i.e., previous image) that has a high correlation with each processing target area. Note that one or more previous images are read from the buffer 124. A known block matching process or the like may be used as the search method. In the first embodiment, the non-search range set by the range setting section 122 is excluded from the search target area to prevent a situation in which an inappropriate motion detection process is performed. When the current image and the previous image differ in magnification or distance from the captured object, the size of the current image or the previous image is adjusted so that the current image and the previous image are identical as to the size of the object.

The image blending section 125 aligns (positions) and blends the current image and the previous image based on the detected motion based on the results of the matching process performed by the motion detection section 123. The motion detection section 123 links each processing target area of the processing target image to an area of the reference image. The image blending process is performed by blending (weighted-averaging) each pixel of the processing target image with the corresponding pixel of the reference image. Noise can be reduced by the image blending process. Note that the image blending process is not limited to the noise reduction process. For example, a high-resolution blended image may be acquired by applying a known super-resolution process that utilizes a plurality of images.

Since the method according to the first embodiment sets the non-search range that is not subjected to the block matching process to the reference image, an area that corresponds to the processing target area of the processing target image may not be present in the reference image. In this case, the image blending process may not be performed on the processing target area. Alternatively, a motion vector may be detected in a plurality of areas using a known motion vector detection method. When a motion vector cannot be detected (i.e., an area that corresponds to the processing target area of the processing target image is not detected in the reference image), a plurality of motion vectors that correspond to the peripheral area of the processing target area may be blended to calculate the motion vector that corresponds to the processing target area.

The post-processing section 126 performs image processing (e.g., grayscale transformation and edge enhancement) on the image obtained by the image blending process performed by the image blending section 125.

The output section 127 outputs the image subjected to image processing by the post-processing section 126 to a display (not illustrated in FIG. 1) or the like.

When using a wide-angle lens (particularly a fish-eye lens) as the condenser lens S07, the peripheral area of the acquired image is significantly affected by distortion of the lens as compared with the center area of the acquired image. When the position of the attention object within the image has moved from the center area to the peripheral area (or moved from the peripheral area to the center area) when the motion detection section 123 performs the block matching process, the shape of the object changes to a large extent in the peripheral area due to a large amount of distortion, so that it is difficult to implement matching with the previous image.

According to the first embodiment, since the range setting section 122 sets the peripheral area of the image that corresponds to the peripheral area of the objective lens of the imaging section in which a large amount of distortion occurs as the non-search range to exclude the non-search range from the block matching search area, it is possible to prevent a situation in which wrong matching results are obtained. Therefore, an inappropriate blended image is not generated. The above effect is particularly advantageous when using a wide-angle lens (particularly a fish-eye lens having an angle of view of more than 180°) as the objective lens. Moreover, since the search range can be limited to a narrow range as compared with the case where the method according to the first embodiment is not used, the search time can be reduced.

The endoscope apparatus according to the first embodiment may include the zoom lens S09 that adjusts the zoom magnification (see FIG. 1). The zoom lens S09 is disposed to have the same optical axis as the condenser lens S07, and can move along the optical axis within a given range. In this case, the size of the non-search range (or the search range) may be changed corresponding to the movement of the zoom lens S09 (i.e., corresponding to a change in zoom magnification). The details thereof are described below.

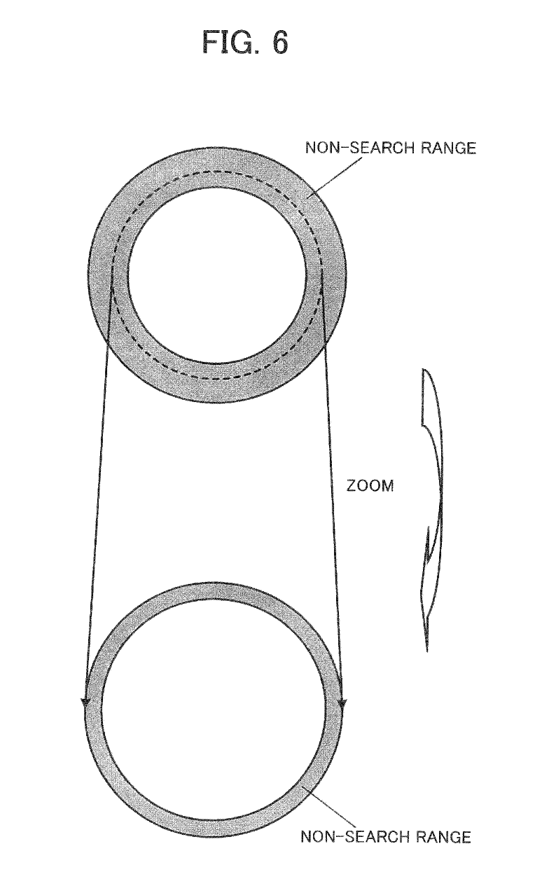

When the zoom lens S09 is driven to the TELE side under control of the control section 128, the center area of the image is magnified, and an area around the edge of the peripheral area of the previous image is not included in the current image range (i.e., is positioned outside the observation field of view of the endoscope apparatus). In the example illustrated in FIG. 6, the reference image is captured only within the range indicated by the broken line when the zoom magnification has increased. In order to deal with this problem, the position of the non-search range set by the range setting section 122 is moved corresponding to the moving amount of the zoom lens S09 that corresponds to the zoom magnification. More specifically, when the zoom magnification of the zoom lens S09 has been increased when capturing an image, the range setting section 122 moves the boundary between the search range and the non-search range toward the edge of the image by a distance that corresponds to the amount of change in zoom magnification (see FIG. 6).

Since the angle of view decreases as the zoom magnification increases, the amount of distortion or the like decreases in the peripheral area of the image as compared with the case where the zoom magnification is low (i.e., the angle of view is wide). Specifically, the size of the area that can be subjected to the motion detection process (e.g., block matching process) without any problem, and can be set as the search range (or excluded from the non-search range) increases. Therefore, the range setting section 122 performs at least one of a search range enlargement process and a non-search range reduction process. This makes it possible to increase the size of the area of the reference image that can be subjected to the motion detection process, so that the possibility that the motion information is detected (i.e., the possibility that results with certain accuracy can be obtained) increases.

Note that the observation field of view of the endoscope apparatus decreases when the imaging section 110 has relatively approached the object even if the zoom magnification is constant, so that the effects of distortion decrease in the same manner as in the case where the zoom magnification is increased. Therefore, the range setting section 122 may move the boundary between the search range and the non-search range toward the edge of the image (see FIG. 6) by a distance that corresponds to the amount of change in relative distance between the imaging section 110 and the object as the relative distance between the imaging section 110 and the object decreases.

When both the zoom magnification and the relative distance change, the moving amount of the boundary between the search range and the non-search range may be determined taking account of the amount of change in zoom magnification and the amount of change in relative distance.

According to the first embodiment, the endoscope apparatus includes the imaging section 110 that captures a plurality of images in time series using an objective optical system (corresponding to the condenser lens S07), the range setting section 122 that sets at least one of a search range and a non-search range to a reference image among the plurality of images, the motion detection section 123 that performs a motion detection process that detects a motion between a processing target image and the reference image, the processing target image being an image among the plurality of images that differs from the reference image, and the image blending section 125 that blends the processing target image and the reference image based on results of the motion detection process (see FIG. 1). The motion detection section 123 sets a processing target area to the processing target image, and performs the motion detection process by searching an area that corresponds to the processing target area at least within the search range set to the reference image when the range setting section 122 has set the search range. The motion detection section 123 performs the motion detection process by searching an area that corresponds to the processing target area at least within a range other than the non-search range when the range setting section 122 has set the non-search range. Note that the search range is set to be a range that includes the center area of the reference image, and the non-search range is set to be a range that includes the peripheral area of the reference image.

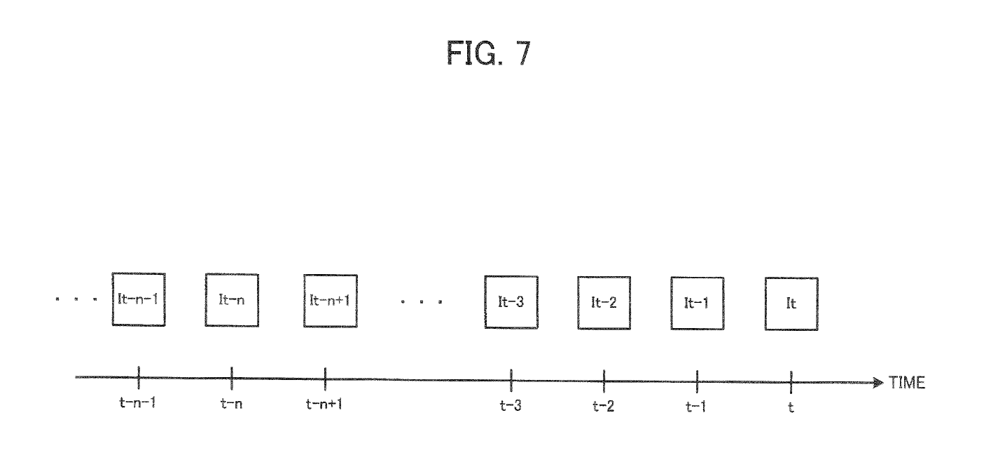

The processing target image is an image among the plurality of images captured in time series that is subjected to processing. The reference image is an image among the plurality of images captured in time series that is subjected to the motion detection process together with the processing target image. The processing target image is the current (latest) image in a narrow sense, and the reference image is a previous image in a narrow sense. For example, a plurality of images are acquired in time series as illustrated in FIG. 7. In FIG. 7, the horizontal axis indicates time, and Iₖ indicates the captured image acquired at a time k. When the time t is the current (latest) time, the image Iₜ may be used as the processing target image, and an arbitrary previous image may be used as the reference image. In this case, the image Iₜ₋₁ acquired immediately prior to the image Iₜ may be used as the reference image, or an arbitrary image acquired prior to the image Iₜ₋₁ may be used as the reference image. Note that the processing target image and the reference image are not limited thereto. For example, an image (e.g., image Iₜ₋₁) acquired at a time prior to the current time may be used as the processing target image, and an arbitrary image (e.g., image Iₜ₋₂) acquired prior to the processing target image may be used as the reference image. The reference image is not limited to an image that has been acquired prior to the processing target image, but may be an image acquired after the processing target image has been acquired. For example, the image Iₜ₋₁ may be used as the processing target image, and the image Iₜ may be used as the reference image. A plurality of reference images may be selected instead of selecting only one reference image. For example, the images Iₜ₋₁ and Iₜ₋₂ may be used as the reference images when the image Iₜ is used as the processing target image.

The above configuration makes it possible to limit the area subjected to the motion detection process when detecting the motion between a plurality of images that have been acquired in time series and are blended. More specifically, at least one of the search range that includes the center area and the non-search range that includes the peripheral area is set to the reference image, and the search process is performed within the search range or the range outside the non-search range. This means that the search process is performed within the range that includes the center area, and is not performed within the range that includes the peripheral area. For example, when using an objective optical system (e.g., fish-eye lens) having a very wide angle of view, the peripheral area of the captured image is significantly affected by distortion or the like as compared with the center area, so that it may be difficult to accurately detect the motion by the block matching process or the like. Since the method according to the first embodiment excludes the range that is significantly affected by distortion or the like from the search range, it is possible to prevent a situation in which wrong motion information is detected when it is difficult to detect the motion. This makes it possible to reduce the possibility that a motion that significantly differs from the actual motion (e.g., the relative motions of the imaging section 110 and the object) is detected, and prevent a situation in which the subsequent image blending process is adversely affected (e.g., the effects of the process are reduced). Note that the first embodiment may also be applied to the case where a wide-angle optical system is not used. For example, the first embodiment may be applied to the case where the luminance significantly decreases in the peripheral area of the image, and it is difficult to detect the motion because of insufficient light intensity due to the configuration of the light source section, the relative positional relationship between the imaging section 110 and the object, or the like.

The range setting section 122 may reduce the size of the non-search range set to the reference image (see FIG. 6) as the zoom magnification of the objective optical system increases. The range setting section 122 may increase the size of the search range set to the reference image as the zoom magnification of the objective optical system increases.

The range setting section 122 may reduce the size of the non-search range set to the reference image as the imaging section 110 approaches the observation target. The range setting section 122 may increase the size of the search range set to the reference image as the imaging section 110 approaches the observation target.

The above configuration makes it possible to change at least one of the search range and the non-search range corresponding to a change in zoom magnification of the imaging section 110. When the zoom magnification of the imaging section 110 has increased (e.g., when the zoom lens S09 has been driven to increase the zoom magnification), the object is captured within a narrow range as compared with the range before the zoom magnification has increased. Specifically, since the angle of view of the optical system decreases, the effects of distortion or the like decrease as compared with the case where the zoom magnification is not increased. This means that the size of the area that undergoes distortion to such an extent that it is difficult to detect the motion decreases. Therefore, the size of the range (i.e., the range outside the search range, or the non-search range) that is not subjected to the motion detection process can be reduced. In other words, since it is possible to increase the size of the range (i.e., the search range or the range outside the non-search range) subjected to the motion detection process, the possibility that the motion is detected (e.g., the matching process succeeds) increases, so that the effects of the image blending process can be improved, for example. Note that the capturing range of the object also decreases (i.e., the angle of view decreases) when the relative distance between the imaging section 110 and the object has decreased (i.e., when the imaging section 110 has approached the object). The above description similarly applies to such a case.

The motion detection section 123 may set the processing target area to the center area of the processing target image, and may perform the motion detection process by searching an area of the reference image that corresponds to the processing target area.

This makes it possible to also limit the range of the processing target area set to the processing target image. The first embodiment is based on the assumption that the peripheral area of the image is not suitable for the motion detection process as compared with the center area of the image. For example, when using a fish-eye lens, while distortion occurs to only a small extent in the center area of the image, distortion occurs to a large extent in the peripheral area of the image. Therefore, when an identical object is captured in the center area of a first image, and captured in the peripheral area of a second image, it may be difficult to successfully implement the matching process due to the effects of distortion or the like. Specifically, the possibility that an incorrect motion is detected can be further reduced by excluding the peripheral area of the reference image from the search range, and excluding the peripheral area of the processing target image from the search range. In this case, the processing target area (i.e., a matching unit block subjected to the block matching process in a narrow sense) is set to the center area of the processing target image, and is not set to the peripheral area of the processing target image.

The range setting section 122 may set a range that is situated on the outer side of a position away from the center of the image by α% (α is a value that satisfies 0<α<100) of the distance from the center of the image to the outer edge of the image, as the non-search range (see FIG. 2). The range setting section 122 may set a range that is situated on the inner side of a position away from the center of the image by α% of the distance from the center of the image to the outer edge of the image, as the search range. In this case, the range setting section 122 may increase the value α as the zoom magnification of the objective optical system increases. The range setting section 122 may increase the value α as the imaging section 110 approaches the observation target (object).

This makes it possible to set at least one of the search range and the non-search range to have the shape illustrated in FIG. 2. In the first embodiment, since the search process is performed within the range that includes the center area, and is not performed within the range that includes the peripheral area when using a fish-eye lens or the like, the range setting illustrated in FIG. 2 satisfies the conditions. The above configuration also makes it possible to more easily set at least one of the search range and the non-search range using a small number of parameters. It is easy to deal with the case of deforming the search range or the non-search range corresponding to a change in zoom magnification (or a change in relative distance between the imaging section 110 and the object) by increasing the parameter a as the zoom magnification increases (or the relative distance decreases).

The image blending section 125 may blend the pixel value of a pixel of the processing target image and the pixel value of a pixel of the reference image based on the results of the motion detection process to reduce a noise component contained in the processing target image.

This makes it possible to implement a noise reduction process as the image blending process. When reducing noise by blending (e.g., weighted-averaging) the pixel values, it is impossible to effectively reduce noise if the pixels that correspond to an identical object are not blended. It is possible to effectively reduce noise by appropriately detecting the motion using the method according to the first embodiment. Note that the blending target pixels need not necessarily strictly correspond to an identical position of an identical object (i.e., a small shift is allowed). The image blending process need not necessarily blend each pixel of one image with each pixel of another image. For example, the image blending process may blend each pixel of the processing target image with a plurality of pixels of the reference image.

The image blending section 125 may blend the pixel value of a pixel of the processing target image and the pixel value of a pixel of the reference image based on the results of the motion detection process to acquire an output image that has a number of pixels larger than that of the processing target image and the reference image.

This makes it possible to implement a process that acquires an image having a resolution higher than that of the original image (processing target image and reference image) as the image blending process. In order to acquire a high-resolution image, it is necessary to acquire a plurality of images that are shifted on a subpixel basis using a pixel shift technique, and blend the plurality of images. If the motion is detected on a subpixel basis using the motion detection process according to the first embodiment, the process that blends the processing target image and the reference image corresponds to the process that blends a plurality of images that are shifted on a subpixel basis. Therefore, the number of pixels of the output image can be increased as compared with the original image.

The imaging section 110 may include an optical system that has an angle of view of larger than 180° as the objective optical system.

This makes it possible to also apply the method according to the first embodiment when using a super-wide angle objective optical system. A fish-eye lens or the like may typically be used as such an optical system. The image undergoes distortion to a large extent at a position away from the optical axis of the optical system (i.e., the peripheral area of the captured image) as the angle of view increases. Therefore, it is effective to use the method according to the first embodiment that excludes the peripheral area of the image from the search range.

The first embodiment may be applied to a program that causes a computer to function as an image acquisition section that captures a plurality of images in time series, the range setting section 122 that sets at least one of a search range and a non-search range to a reference image among the plurality of images, the motion detection section 123 that performs a motion detection process that detects a motion between a processing target image and the reference image, the processing target image being an image among the plurality of images that differs from the reference image, and the image blending section 125 that blends the processing target image and the reference image based on results of the motion detection process. The motion detection section 123 sets a processing target area to the processing target image, and performs the motion detection process by searching an area that corresponds to the processing target area at least within the search range set to the reference image when the range setting section 122 has set the search range. The motion detection section 123 performs the motion detection process by searching an area that corresponds to the processing target area at least within a range other than the non-search range when the range setting section 122 has set the non-search range. Note that the search range is set to be a range that includes the center area of the reference image, and the non-search range is set to be a range that includes the peripheral area of the reference image.

This makes it possible to implement a program that implements the above process. The program may be executed by the processor section 120 included in the endoscope apparatus illustrated in FIG. 1. When the endoscope apparatus captures, stores, and transmits/receives an image, and a processing system (e.g., PC) that is provided separately from the endoscope apparatus performs the above process, the program may be read and executed by the CPU of the PC or the like. The program is stored in a storage device (information storage device). The storage device may be an arbitrary recording device that is readable by an optical detection system, such as an optical disk (e.g., DVD and CD), a magnetooptical disk, a hard disk (HDD), and a memory (e.g., nonvolatile memory and RAM).

### 3. Second Embodiment

An endoscope apparatus according to the second embodiment is basically configured in the same manner as the endoscope apparatus according to the first embodiment. Therefore, detailed description thereof is omitted, and only the differences from the endoscope apparatus according to the first embodiment are described below. In the second embodiment, the omnidirectional optical system illustrated in FIG. 3 is used as the condenser lens S07. The optical system has surfaces SF1 to SF3. Light LC1 applied from the front passes through the surfaces SF1 and SF2, and reaches the image sensor S08. Light LC2 applied from the side passes through the surface SF3, is reflected by the surfaces SF1 and SF2, and reaches the image sensor S08. This makes it possible to guide the light LC1 applied from the front and the light LC2 applied from the side to the image sensor S08, and observe the front field of view and the side field of view. Note that the configuration of the omnidirectional optical system is not limited to the configuration illustrated in FIG. 3. The omnidirectional optical system may include a first lens for observing the front field of view, and a second lens for observing the side field of view. FIG. 4A is a front cross-sectional view illustrating the imaging section 110, and FIG. 4B is a side cross-sectional view illustrating the imaging section 110.

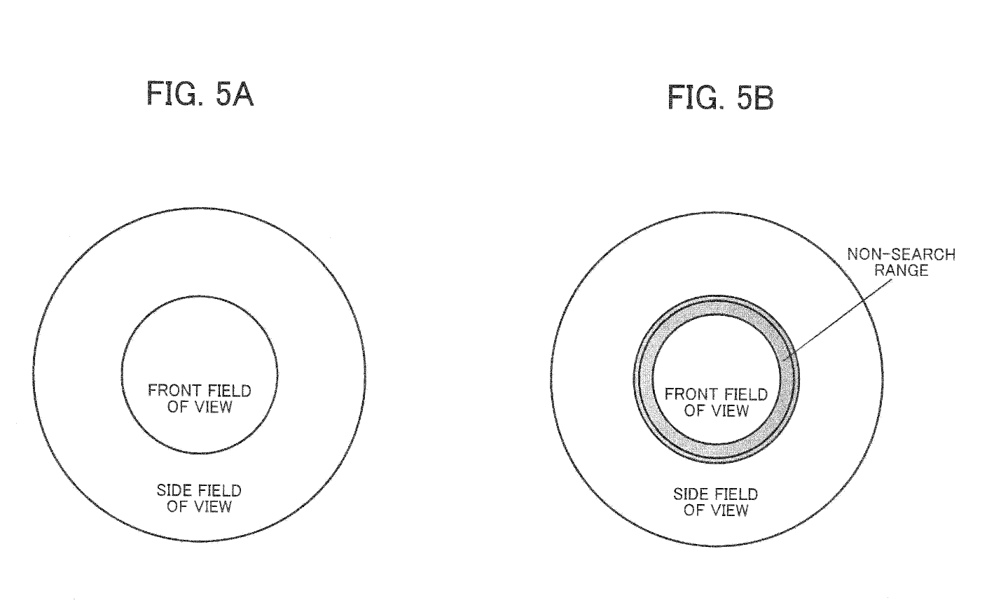

Since an image that corresponds to the front field of view and an image that corresponds to the side field of view can be acquired when using such an optical system, the captured image illustrated in FIG. 5A is presented to the user, for example. In this case, a dark boundary area may occur in the captured image between the front area that corresponds to the front field of view and the side area that corresponds to the side field of view. In particular, since the light intensity decreases (gradation occurs) in an area around the front area (front field of view) due to the lens of the refracting system, the boundary area is formed as a black strip-like area that is connected to the gradation area. The black strip-like area occurs due to a blind spot between the front field of view and the side field of view (see FIG. 4B), or occurs when the light intensity is insufficient in the peripheral area of the front field of view.

Therefore, the luminance may decrease in the boundary area due to insufficient light intensity, so that it may be impossible to appropriately acquire a feature quantity necessary for matching (e.g., object shape or edge matching). The boundary area may be misidentified as the edge of the object, so that it may be impossible to implement appropriate matching.

In the second embodiment, the range setting section 122 sets the non-search range to the area that corresponds to the boundary area under control of the control section 128. Note that the non-search range need not necessarily include the boundary area.

When the image illustrated in FIG. 5A is acquired as the captured image, a peripheral area that includes the boundary between the image area that corresponds to the front field of view and the image area that corresponds to the side field of view is set as the non-search range (see FIG. 5B). More specifically, the non-search range may be set to include the peripheral area of the image that corresponds to the front field of view, the peripheral area being positioned on the outer side of a boundary that is positioned away from the boundary between the image area that corresponds to the front field of view and the image area that corresponds to the side field of view by a given distance. Note that the range setting section 122 may set the search range which includes the center area of the image that corresponds to the front field of view and in which an area (reference area) having a high correlation with the processing target area of the processing target image is searched, or may set both the search range and the non-search range.

The position of the boundary in the captured image is determined from the design information about the lens, a method that blends the image area that corresponds to the front field of view and the image area that corresponds to the side field of view, or the like. The non-search range (or the search range) may be set in advance by acquiring such information. The user may set the non-search range (or the search range) in advance via the I/F section 130.

The first and second embodiments to which the invention is applied and the modifications thereof have been described above. Note that the invention is not limited thereto. Various modifications and variations may be made of the first and second embodiments and the modifications thereof without departing from the scope of the invention. A plurality of elements described in connection with the first and second embodiments and the modifications thereof may be appropriately combined to implement various configurations. For example, an arbitrary element may be omitted from the elements described in connection with the first and second embodiments and the modifications thereof. Some of the elements described in connection with different embodiments or modifications thereof may be appropriately combined. Specifically, various modifications and applications are possible without materially departing from the novel teachings and advantages of the invention.

What is claimed is:

1. An endoscope apparatus comprising:
an imaging section that captures a plurality of images in time series using an objective optical system;
a range setting section that sets at least one of a search range and a non-search range to a reference image among the plurality of images, the search range including a center area of the reference image, and the non-search range including a peripheral area of the reference image;
a motion detection section that performs a motion detection process that detects a motion between a processing target image and the reference image, the processing target image being an image among the plurality of images that differs from the reference image; and
an image blending section that blends the processing target image and the reference image based on results of the motion detection process,
the motion detection section setting a processing target area to the processing target image, performing the motion detection process by searching an area that corresponds to the processing target area at least within the search range set to the reference image when the range setting section has set the search range, and performing the motion detection process by searching an area that corresponds to the processing target area at least within a range other than the non-search range when the range setting section has set the non-search range.

2. The endoscope apparatus as defined in claim 1,
the range setting section performing at least one of a process that reduces a size of the non-search range set to the reference image as a zoom magnification of the objective optical system increases, and a process that increases a size of the search range set to the reference image as the zoom magnification of the objective optical system increases.

3. The endoscope apparatus as defined in claim 1,
the range setting section performing at least one of a process that reduces a size of the non-search range set to the reference image as the imaging section approaches an observation target, and a process that increases a size of the search range set to the reference image as the imaging section approaches the observation target.

4. The endoscope apparatus as defined in claim 1,
the motion detection section setting the processing target area to a center area of the processing target image, and performing the motion detection process by searching an area of the reference image that corresponds to the processing target area.

5. The endoscope apparatus as defined in claim 1,
the range setting section setting a range that is situated on an outer side of a position away from a center of an image by α% (α is a value that satisfies 0<α<100) of a distance from the center of the image to an outer edge of the image, as the non-search range.

6. The endoscope apparatus as defined in claim 1,
the range setting section setting a range that is situated on an inner side of a position away from a center of an image by α% (α is a value that satisfies 0<α<100) of a distance from the center of the image to an outer edge of the image, as the search range.

7. The endoscope apparatus as defined in claim 5,
the range setting section increasing the value α as a zoom magnification of the objective optical system increases.

8. The endoscope apparatus as defined in claim 6,
the range setting section increasing the value α as a zoom magnification of the objective optical system increases.

9. The endoscope apparatus as defined in claim 5,
the range setting section increasing the value α as the imaging section approaches an observation target.

10. The endoscope apparatus as defined in claim 6,
the range setting section increasing the value α as the imaging section approaches an observation target.

11. The endoscope apparatus as defined in claim 1,
the image blending section blending a pixel value of a pixel of the processing target image and a pixel value of a pixel of the reference image based on the results of the motion detection process to reduce a noise component contained in the processing target image.

12. The endoscope apparatus as defined in claim 1,
the image blending section blending a pixel value of a pixel of the processing target image and a pixel value of a pixel of the reference image based on the results of the motion detection process to acquire an output image that has a number of pixels larger than that of the processing target image and the reference image.

13. The endoscope apparatus as defined in claim 1,
the imaging section including an optical system that has an angle of view of larger than 180° as the objective optical system.

14. An image processing method comprising:
setting at least one of a search range and a non-search range to a reference image among a plurality of images captured in time series using an objective optical system, the search range including a center area of the reference image, and the non-search range including a peripheral area of the reference image;
setting a processing target area to a processing target image among the plurality of images that differs from the reference image;
performing a motion detection process by searching an area that corresponds to the processing target area at least within the search range set to the reference image when the search range has been set to the reference image;
performing the motion detection process by searching an area that corresponds to the processing target area at least within a range of the reference image other than the non-search range when the non-search range has been set to the reference image; and
blending the processing target image and the reference image based on results of the motion detection process.

15. A computer-readable storage device with an executable program stored thereon, wherein the program instructs a computer to perform steps of:
capturing a plurality of images in time series;
setting at least one of a search range and a non-search range to a reference image among the plurality of images, the search range including a center area of the reference image, and the non-search range including a peripheral area of the reference image;
performing a motion detection process that detects a motion between a processing target image and the reference image, the processing target image being an image among the plurality of images that differs from the reference image; and
blending the processing target image and the reference image based on results of the motion detection process,
the motion detection process setting a processing target area to the processing target image, searching an area that corresponds to the processing target area at least within the search range set to the reference image when the search range has been set to the reference image, and searching an area that corresponds to the processing target area at least within a range other than the non-search range when the non-search range has been set to the reference image.
